(19) United States
(12) Patent Application Publication
(10) Pub. No.: US 2015/0321606 A1
(43) Pub. Date: Nov. 12, 2015

(54) ADAPTIVE CONVEYANCE OPERATING SYSTEM

(71) Applicant: HJ Laboratories, LLC, Philadelphia, PA (US)

(72) Inventors: Harry Vartanian, Philadelphia, PA (US); Jaron Jurikson-Rhodes, Philadelphia, PA (US)

(73) Assignee: HJ Laboratories, LLC, Philadelphia, PA (US)

(21) Appl. No.: 14/274,285

(22) Filed: May 9, 2014

(51) Int. Cl. B60R 1/00; G02B 27/01

(52) U.S. Cl. CPC B60R 1/00; G02B 27/0179; G02B 2027/014; G02B 2027/0138; B60R 2300/10; B60R 2300/205; B60R 2300/304

(57) ABSTRACT

An apparatus, method, or system for providing specialized platforms and computing environments for vehicles/conveyances to coexist with end user devices is disclosed. Provided configurations and operations may apply to autonomous vehicles/conveyances. Vehicle/conveyance operating systems (OSs) that provide augmented reality, mixed reality, hybrid reality, virtual reality, or artificial intelligence (AI) are also provided. Also provided are new devices or processes for vehicles/conveyances that are useful for any mobile device, such as a mobile computer, smartphone, tablet, wearable computer, or the like.

### BACKGROUND

Personal computing is becoming commonplace and integrated, directly or indirectly, in vehicles/conveyances. It will soon become ubiquitous in automobiles, especially in autonomous vehicles/conveyances. Personal computing environments may be provided by electronic devices such as general computers, controllers, tablets, mobile devices, cellular phones, personal digital assistants, smartphones, tablet personal computers (PCs), laptop computers, notebook computers, televisions, digital picture frames, large displays, smart watches, wearable computers, optical head-mounted displays (OHMDs), or the like to vehicles/conveyances.

The operating systems (OSs) on electronic devices require better alignment with their corresponding components (software or hardware) on vehicles/conveyances for delivering desirable user experiences. More alignment is especially needed for autonomous vehicle/conveyance systems, to increase user productivity in vehicles, vehicle/user collaboration, providing advanced vehicle services, or the like. This may require completely altering existing software/hardware platforms or creating completely new software/hardware platforms that fit the unique operating environments of vehicles/conveyances.

Augmented reality, mixed reality, hybrid reality, or virtual reality may soon become standard equipment on vehicles/conveyances and become mainstream end user devices to be used with vehicles/conveyances. This may create a coexistence problem since computing platforms for augmented reality, mixed reality, hybrid reality, or virtual reality in vehicles/conveyances are designed very differently than corresponding computing platforms in end user devices.

Therefore, to advance progress, it is desirable to provide devices that deliver better operating environments and platforms for vehicle/conveyance type environments or the like.

### SUMMARY

An apparatus, method, or system for providing specialized platforms and computing environments for vehicles/conveyances to coexist with end user devices is disclosed. In addition, operating systems (OSs) optimized for vehicle/conveyance/automobile systems and configured to streamline communication/coordination of electronic devices in a driving environment are provided. Provided configurations and processes may especially be needed for autonomous vehicles/conveyances. Vehicle/conveyance OSs that provide augmented reality, mixed reality, hybrid reality, virtual reality, or artificial intelligence (AI) are also provided.

Also provided are new devices or processes for vehicles/conveyances that are useful for any mobile device, such as a mobile computer, smartphone, tablet, wearable computer, etc.

### BRIEF DESCRIPTION OF THE DRAWINGS

A more detailed understanding may be had from the following description given in conjunction with the accompanying drawings wherein:

FIG. 1 is a diagram of an object device or electronic device;

FIG. 2 is a diagram of a vehicle/conveyance;

FIG. 3 is a diagram of a vehicle/conveyance computing platform or operating system (OS);

FIG. 3a is a diagram of a steering wheel with a display;

FIG. 4 is a diagram of a vehicle/conveyance environmental detection;

FIG. 5 is a diagram of an advance input determination configuration;

FIG. 6 is a process of a vehicle/conveyance computing or OS platform; and

FIG. 7 is a diagram of a process of advance input determination.

### DETAILED DESCRIPTION

Any of the devices or processes given herein for vehicles/conveyances may also apply to any mobile device, such as a mobile computer, smartphone, tablet, optical head-mounted display (OHMD), wearable computer, etc. Also, vehicle, conveyance, or automobile may be used interchangeably throughout this disclosure.

Devices or processes will be described with reference to the drawing figures wherein like numerals represent like elements throughout. For the methods and processes described below the steps recited may be performed out of sequence in any order and sub-steps not explicitly described or shown may be performed. In addition, “coupled” or “operatively coupled” may mean that objects are linked but may have zero or more intermediate objects between the linked objects. Also, any combination of the disclosed features/elements may be used in one or more embodiments. When using referring to “A or B”, it may include A, B, or A and B, which may be extended similarly to longer lists. When using the notation X/Y it may include X or Y. Alternatively, when using the notation X/Y it may include X and Y. X/Y notation may be extended similarly to longer lists with the same explained logic.

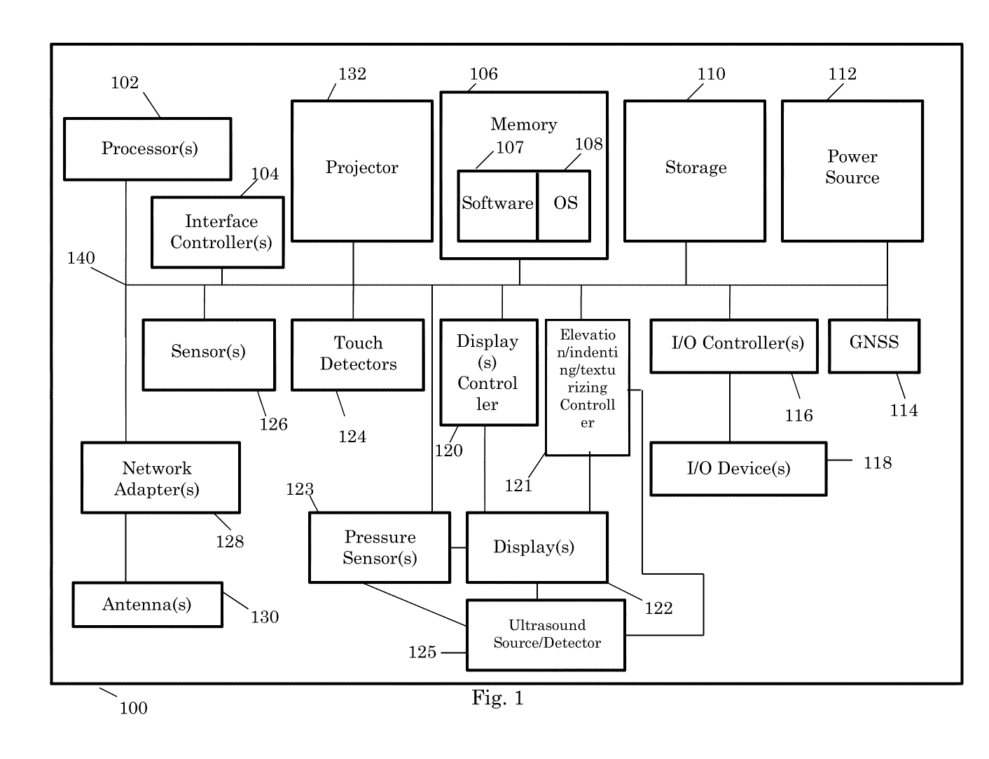

FIG. 1 is a diagram of an object device, or electronic device, 100 that may be configured in vehicles/conveyances. Object device 100 may operate as an integrated component in a vehicle/conveyance or in wired/wireless communication with a vehicle/conveyance. Object device 100 may be configured as one or more of an automobile/vehicle/conveyance computer system, automobile/vehicle/conveyance controller, a general computer, wireless subscriber unit, mobile device, user equipment (UE), mobile station, smartphone, pager, mobile computer, cellular phone, cellular telephone, telephone, personal digital assistant (PDA), computing device, surface computer, tablet, tablet computer, tablet/laptop combo device, sensor, machine, monitor, general display, versatile device, digital picture frame, appliance, television device, home appliance, home computer system, laptop, netbook, personal computer (PC), an Internet pad, digital music player, peripheral, add-on, an attachment, virtual reality glasses, media player, video game device, head-mounted display (HMD), helmet mounted display (HMD), glasses, goggles, wearable computer, wearable headset computer, optical head-mounted display (OHMD), Internet of Things (IoT) device, or any other electronic device for mobile or fixed applications.

Object device 100 comprises computer bus 140 that couples one or more processors 102, one or more interface controllers 104, memory 106 having software 107 or operating system (OS) 108, storage device 110, power source 112, and/or one or more displays controller 120. OS 108 may be based on one or more of Windows, OS X, WebOS, Linux, Unix, iOS, Android, QNX, C++, Java, or the like. OS 108 may include a kernel component that may manage input/output requests from software 107 in memory 106. The kernel may translate the request into data processing instructions for one or more processors 102 and other components of object device 100.

In addition, object device 100 may comprise an elevation, indenting, or texturizing controller 121 to provide sensations to an object or person located near one or more display devices 122. One or more display devices 122 can be configured as a plasma, liquid crystal display (LCD), light emitting diode (LED), field emission display (FED), surface-conduction electron-emitter display (SED), organic light emitting diode (OLED), flexible OLED, a projection display, 4K display, high definition (HD) display, a Retina© display, In-Plane Switching (IPS) based display, or any other display device. The one or more display devices 122 may be configured, manufactured, produced, or assembled based on the descriptions provided in U.S. Patent Publication Nos. 2006-0096392, 2007-0139391, 2007-0085838, or 2011-0037792 or U.S. Pat. Nos. 6,882,333, 7,050,835, 8,400,384, or 8,466,873, or WO Publication No. 2007-012899 that are all herein incorporated by reference as if fully set forth.

In the case of a flexible or bendable display device, the one or more electronic display devices 122 may be configured and assembled using organic light emitting diodes (OLED), liquid crystal displays using flexible substrate technology, flexible transistors, field emission displays (FED) using flexible substrate technology, or the like. Any one of the provided display devices herein may be self-lighting or use backlighting sources (e.g. LED, Cold Cathode Fluorescent Lamp (CCFL), etc.) One or more display devices 122 may be wholly or partially transparent, using one of the display technologies mentioned herewith.

One or more display devices 122 can be configured as a touch, multi-input touch, multiple input touch, multiple touch, or multi-touch screen display using resistive, capacitive, surface-acoustic wave (SAW) capacitive, infrared, strain gauge, optical imaging, dispersive signal technology, acoustic pulse recognition, frustrated total internal reflection, or magneto-strictive technology, as understood by one of ordinary skill in the art. One or more display devices 122 can also be configured as a three dimensional (3D), electronic paper (e-paper), or electronic ink (e-ink) display device.

Coupled to one or more display devices 122 may be pressure sensors 123. Coupled to computer bus 140 may be one or more input/output (I/O) controllers 116, I/O devices 118, global navigation satellite system (GNSS) device 114, one or more network adapters 128, and/or one or more antennas 130. Examples of I/O devices include a speaker, microphone, keyboard, keypad, touchpad, display, touchscreen, wireless gesture device, a camera, a digital camera, a digital video recorder, a vibration device, universal serial bus (USB) connection, a USB device, or the like. An example of GNSS is the Global Positioning System (GPS). The camera may be digital single-lens reflex (DLSR) camera, single-lens reflex (SLR) camera, or the like. The digital camera may also be configured to generate images that are then adjusted using high-dynamic-range (HDR) image processing.

Object device 100 may have one or more motion, proximity, light, optical, chemical, biological, medical, environmental, barometric, atmospheric pressure, moisture, acoustic, audible, heat, temperature, metal detector, radio frequency identification (RFID), biometric, face recognition, facial recognition, image, infrared, camera, photo, or voice recognition sensor(s) 126. Examples of image, photo, text, or character recognition engines are provided by U.S. Patent Publication Nos. 2011-0110594 or 2012-0102552 that are both herein incorporated by reference as if fully set forth.

One or more sensors 126 may also be an accelerometer, an electronic compass (e-compass), a gyroscope, a 3D gyroscope, a 3D accelerometer, a 4D gyroscope, a 4D accelerometer, or the like. One or more sensors 126 may operate with respective software engines/components in software/OS 108 to interpret/discern/process detected measurements, signals, fields, stimuli, inputs, or the like.

Object device 100 may also have touch detectors 124 for detecting any touch inputs, multi-input touch inputs, multiple input touch inputs, multiple touch inputs, or multi-touch inputs for one or more display devices 122. Touch detectors 124 may be configured with one or more display devices 122 as provided in U.S. U.S. Pat. No. 6,323,846 or U.S. Pat. No. 7,705,830 that are both herein incorporated by reference as if fully set forth. One or more interface controllers 104 may communicate with touch detectors 124 and I/O controllers 116 for determining user inputs to object device 100. Coupled to one or more display devices 122 may be pressure sensors 123 for detecting presses on one or more display devices 122. In another example, touch detectors 124 and/or pressure sensors 123 may be integrated into one or more display devices 122 to determine any user gestures or inputs.

Ultrasound source/detector 125 may be configured in combination with touch detectors 124, elevation, indenting, or texturizing controller 121, one or more display devices 122, pressure sensors 123, or sensors 126 to project or generate ultrasound waves, rays, or beams to an object in order to simulate elevated, indented, or texturized sensations, recognize inputs, or track the object. U.S. Patent Publication No. 2011-0199342 is herein incorporated by reference as if fully set forth and may be used in combination with the given examples to enable a display device to adaptively emit ultrasound, ultrasonic, acoustic, or radio waves. These waves can provide an elevated, indented, or texturized sensation to an object, or person near a display device. There may be cases for input recognition or object tracking wherein an ultrasound is provided without detected sensation to the object.

Still referring to object device 100, storage device 110 may be any disk based or solid state memory device for storing data. Storage device 110 may be configured to work in coordination with cloud based storage (not shown) via one or more network adapters 128. Power source 112 may be a plug-in, battery, solar panels for receiving and storing solar energy, or a device for receiving and storing wireless power as described in U.S. Pat. No. 7,027,311 that is herein incorporated by reference as if fully set forth.

One or more network adapters 128 may be configured as a Frequency Division Multiple Access (FDMA), single carrier FDMA (SC-FDMA), Time Division Multiple Access (TDMA), Code Division Multiple Access (CDMA), Orthogonal Frequency-Division Multiplexing (OFDM), Orthogonal Frequency-Division Multiple Access (OFDMA), Global System for Mobile (GSM) communications, Interim Standard 95 (IS-95), IS-856, Enhanced Data rates for GSM Evolution (EDGE), General Packet Radio Service (GPRS), Universal Mobile Telecommunications System (UMTS), cdma2000, wideband CDMA (W-CDMA), High-Speed Downlink Packet Access (HSDPA), High-Speed Uplink Packet Access (HSUPA), High-Speed Packet Access (HSPA), Evolved HSPA (HSPA+), Long Term Evolution (LTE), LTE Advanced (LTE-A), 802.11x, Wi-Fi, Zigbee, Ultra-WideBand (UWB), 802.16x, 802.15, Wi-Max, mobile Wi-Max, home Node-B (HnB), Bluetooth, radio frequency identification (RFID), Infrared Data Association (IrDA), near-field communications (NFC), fifth generation (5G), or any other wireless or wired device/transceiver for communication via one or more antennas 130.

One or more network adapters 128 may also be configured for automobile to automobile, car to car, vehicle to vehicle (V2V), or wireless access for vehicular environments (WAVE) communication. One or more network adapters 128 may also be configured for human body communications where the human body is used to communicate data between at least two computers coupled to the human body. In addition, any of the communication links referenced herewith may be wired or wireless or both wired and wireless.

Any of devices, controllers, displays, components, etc. in object device 100 may be combined, made integral, or separated as desired. For instance, elevation, indenting, or texturizing controller 121 may be combined with ultrasound source/detector 125 in one unit.

In addition, many of the descriptions forthcoming may be provided within the context of a vehicle/conveyance. Any of the configurations, systems, or operations may be provided in or by object device 100. Any of the configurations, systems, or operations may also be provided in or by any mobile device.

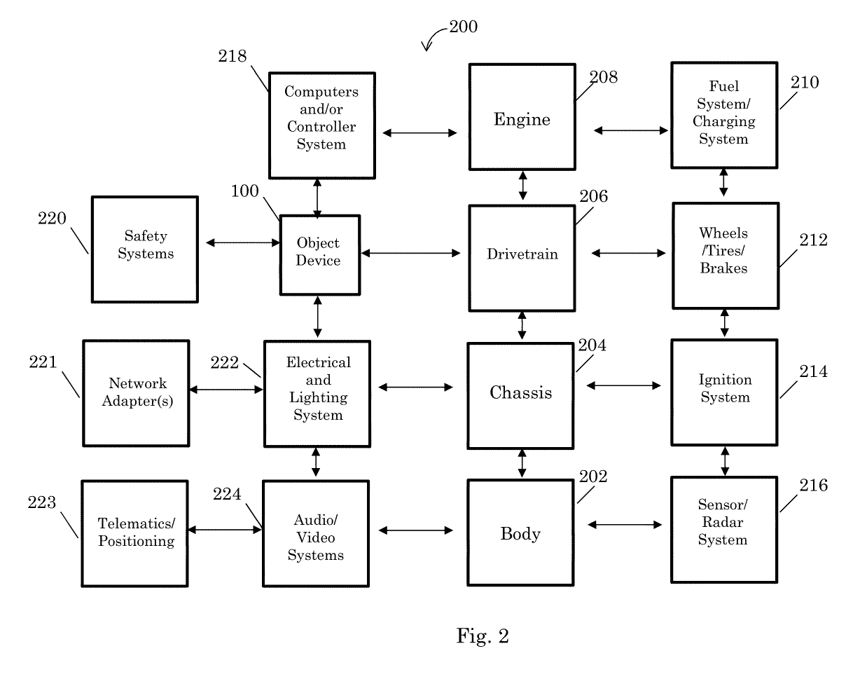

FIG. 2 is a diagram of a vehicle/conveyance 200 that comprises of coupled components vehicle body 202, chassis 204, drivetrain 206, and engine (or motor) 208. Engine (or motor) 208 may be any one (or a combination) of gasoline, diesel, hybrid, hybrid electric, electric, natural gas, hydrogen, fuel cell, or the like. Vehicle/conveyance 200 may also comprise of fuel system/charging system 210, wheels/tires/brakes 212, ignition system 214, or sensor/radar system 216.

The operation or configuration of a gasoline based vehicle/conveyance 200 may be provided by U.S. Pat. Nos. 5,045,035, 5,257,674, or 5,305,720 or U.S. Patent Publication. No. 2013/284,146 that are all herein incorporated by reference as if fully set forth. The operation or configuration of a diesel based vehicle/conveyance 200 may be provided by U.S. Pat. No. 6,729,303 that is herein incorporated by reference as if fully set forth. The operation or configuration of a hybrid or hybrid electric based vehicle/conveyance 200 may be provided by U.S. Pat. Nos. 5,343,970, 5,744,895, 6,441,506, 6,598,945, or 7,463,968 that are all herein incorporated by reference as if fully set forth. The operation or configuration of an electric based vehicle/conveyance 200 may be provided by U.S. Pat. Nos. 5,549,172, 5,821,653, 5,973,463 or 6,227,322 that are all herein incorporated by reference as if fully set forth.

The operation or configuration of a natural gas based vehicle/conveyance 200 may be provided by U.S. Pat. Nos. 5,081,977, 6,210,641 or 8,459,241 that are all herein incorporated by reference as if fully set forth. The operation or configuration of a hydrogen based vehicle/conveyance 200 may be provided by U.S. Pat. No. 7,448,348 that is herein incorporated by reference as if fully set forth. The operation or configuration of a fuel cell based vehicle/conveyance 200 may be provided by U.S. Pat. No. 6,978,855 that is herein incorporated by reference as if fully set forth.

Coupled to the components mentioned above in vehicle/conveyance 200 may be computers and/or controller system 218, object device 100, network adapter(s) 221, electrical and lighting system 222, telematics or positioning devices 223, audio/video systems 224, and safety systems 220. Computers and/or controller system 218 may include one or more engine control units (ECUs) for engine (or motor) 208. Network adapter(s) 221 may be configured similar to one or more network adapters 128. Telematics or positioning devices 223 may be configured similar to global navigation satellite system (GNSS) device 114.

To provide an effective vehicle/conveyance computing platform, an OS, such as 108, may have to primarily balance safety, productivity, and simplicity. OS 108 may have to perform this in real time while working with components of vehicle/conveyance 200. An automobile computing platform as such may be delivered, wholly or in part, by object device 100 being a standalone device, such as smartphone, that has an automobile mode engine in its OS to control and interface with vehicle/conveyance 200. Object device 100 may also be fully integrated with a customized OS into vehicle/conveyance 200 but communicate with other object devices 100, such as smartphones or tablets. Object device 100 may also operate with vehicle/conveyance 200 and its systems via one or more of a direct connection, dock, plugin, connection, wire, wirelessly, or the like.

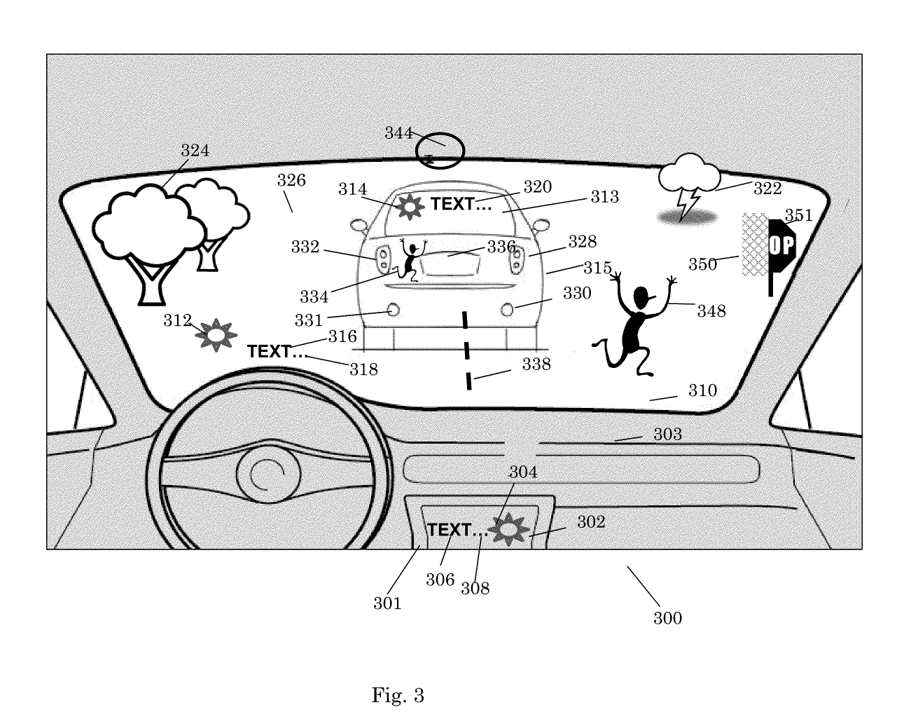

FIG. 3 is a diagram of a vehicle/conveyance 300 with computing platform or OS 301. Vehicle/conveyance 300 may be configured with one or more software/hardware components from object device 100 or vehicle/conveyance 200. In the description below, OS 301 may include parts of an operating system and kernel but also other components/engines/software/applications that are in addition to parts of the scope of current operating systems. OS 301 may be configured and integrate to work with any of the software components, hardware components, or systems of vehicle/conveyance 300 to provide the forthcoming descriptions. OS 301 may also have components, subcomponents, engines, or modules to implement the operations and configurations forthcoming.

OS 301 may be delivered, wholly or in part, by object device 100 being a standalone device, such as smartphone, that has an automobile mode engine in its OS to control and interface with vehicle/conveyance 300. OS 301 may also be delivered by object device 100 that is fully integrated with a customized OS into vehicle/conveyance 300 but also still communicates with other object devices 100 (e.g. smartphones or tablets). OS 301 may also be delivered by object device 100 that operates with vehicle/conveyance 300 and its systems via one or more of a direct connection, dock, plugin, connection, wire, wirelessly, or the like.

Display 302, which may be configured with one or more display devices 122, displays an environment or workspace on dashboard 303. Display 302 may be configured to display weather 304 and message 306 provided in part via network adapter(s) 221. In order to just partially catch a driver's (or passenger's) attention of vehicle/conveyance 300, message 306 may be provided on display 302 in staggered or periodic snippets/widgets. Ellipses 308 may indicate that there is more text to message 306. The periodicity to display a word or content in message 306 may be, for example, anywhere from milliseconds to seconds or even minutes. This configuration of vehicle/conveyance 300 and OS 301 may improve safety since conveying message 306 to the driver(s) (or passenger(s)) of vehicle/conveyance 300 is less distracting.

Moreover, information displayed on display 302 may be replicated/mirrored, in part or wholly, and displayed on windshield 310. In the descriptions forthcoming, windshield 310 may be substantially completely or partially configured to display information. In addition, in the descriptions forthcoming when information is explained as displayed it may be for windshield 310 that is substantially completely or partially configured to display information.

Windshield 310 may have a heads-up display (HUD) (not shown) and/or be integrated with a substantially transparent display device to provide the information on display 302. The HUD may also use transparent phosphors on windshield 310 that reacts when a laser shines on it. A HUD system may also use projection, mirrors, or waveguides. HUD systems are provided in U.S. Pat. Nos. 6,720,938, 7,355,796, 8,164,543, 8,432,614 and U.S. Patent Publication No. 2014/063064 that are all herein incorporated by reference as if fully set forth.

If a transparent display device is integrated or made part of windshield 310, the display may be based on OLED or any of the applicable display devices described herewith for one or more display devices 122. A HUD and/or transparent display may give OS 301 the ability to display information on windshield 310 and also provide augmented reality, mixed reality, hybrid reality, or substantially virtual reality driving environments.

The display system for windshield 310 may be configured to provide night vision to the driver or passenger(s) of vehicle/conveyance 300. Night vision may be provided to a driver (or passenger) of vehicle/conveyance 300 to detect objects/people using one or more of an infrared sensor(s), an infrared camera(s), a camera(s), a range finding camera(s), an acoustic sensor(s), or an ultrasonic sensor(s). Any of these devices may be associated with sensor/radar system 216. Night vision may also be provided by using one or more sensors 126. The night vision system of vehicle/conveyance 300 may be configured as described in U.S. Pat. Nos. 5,729,016, 7,130,486, or 7,312,723 that are all herein incorporated by reference as if fully set forth.

On windshield 310, weather 304 may be displayed as replicated weather 312 and message 306 may be displayed as replicated message 316. Periodic snippets with ellipses 308 are replicated on windshield 310 as periodic snippets with ellipses 318. Similar to message 306, in order to just partially catch a driver's (or passenger's) attention, copied message 316 may be displayed on windshield 310 in staggered or periodic snippets with ellipses 318 indicating that there is more to the message. The periodicity to display each word in replicated message 316 may be anywhere from milliseconds to seconds or even minutes.

Replicated message 316 or message 306, wholly or in part, may be provided via network adapter(s) 221 from Facebook, Instagram, Snapchat, Google+, iMessage, Twitter information, cloud based information, or the like. Replicated message 316 or message 306 may also be one or more of a text message, notification, document, portable document format (PDF), word document, hypertext markup language (HTML) information, webpage, web information, an attachment, slideshow, advertisement, spreadsheet, short message service (SMS) message, multimedia messaging service (MMS) message, electronic mail (email), information from a photostream, information from a Facebook timeline, ticker information, news feed, RSS feed, or the like.

Replicated message 316 may selectively be displayed by OS 301 on windshield 310 depending on driving conditions of vehicle/conveyance 300. Replicated message 316 may appear when vehicle/conveyance 300 is substantially stopped or disappear depending on the motion of vehicle/conveyance 300. In addition, replicated message 316 may disappear depending when vehicle/conveyance 300 is in a dangerous state as determined by OS 301. Also, replicated message 316 may be selectively or dynamically faded to different levels/amounts/shades based on driving conditions. The driving conditions or dangerous state may be detected and provided by OS 301 in part by sensor/radar system 216 or one or more sensors 126.

OS 301 may process replicated message 316 or message 306 to strip out the text from any multimedia content. The multimedia content may be a photo, picture, image, sound, music, video, or the like. Substantially separating or blocking text in a message having multimedia content from displaying on windshield 310 may prevent or lessen driver(s)/passenger(s) distraction. In addition, the text part of replicated message 316 or message 306 may be stripped out, removed, or not displayed on windshield 310 while vehicle/conveyance 200 is in motion. The text part of replicated message 316 or message 306 may be displayed on windshield 310 or display 302 when vehicle/conveyance 200 is stopped or parked. Rather than stripping out the text, replicated message 316 or message 306 may selectively be displayed by OS 301. Selectively displaying may be based on who sent the message, an urgency flag, time of day, time of year, weather conditions, or the like.

In computing platform or OS 301 weather 314 or message 320 may augment/mix the reality of a driver(s)/passenger(s) or display on windshield 310. OS 301 may display weather 314 or message 320 such that the view to a driver(s)/passenger(s) appears substantially in line, in a substantially similar dimensional space, in a substantially same focal plane, in a substantially same field of view, proximately planar, or substantially planar with windshield 313 of vehicle/conveyance 315. This view or display of information relative to windshield 313 may be determined by OS 301 by using eye tracking, eye focus, focal point determination, facial, head, or gaze determination, or the like of a driver(s)/passenger(s). Augmented reality configurations may be provided by OS 301 as explained in U.S. Patent Publication No. 2012/242865 that is herein incorporated by reference as if fully set forth. Any of the displayed information on windshield 310 in descriptions below may be displayed as explained in this paragraph. Driver reaction times may be reduced by this configuration since information and vehicle/conveyance 315 are within substantially similar views. Having information displayed on a windshield as if it is on the back of another conveyance, such as one substantially directly in front, may increase safety and usability.

Appearing substantially in line, in a substantially similar dimensional space, in a substantially same focal plane, in a substantially same field of view, proximately planar, or substantially planar may be a configuration where displayed objects on windshield 310 may be displayed near the back 328 of vehicle/conveyance 315 based on the focus points of driver(s)/passenger(s). By considering focus points, driver reaction times may be reduced since information and vehicle/conveyance 315 are within substantially similar views. Having information displayed on a windshield as if it is on the back of another conveyance, such as one substantially directly in front, may increase safety and usability.

Moreover, eye tracking, eye focus, facial, head, or gaze detection may be provided by OS 301 as described by U.S. Patent Publication Nos. 2014/078282 or 2012/271484 or U.S. Pat. No. 8,391,554 or U.S. Pat. No. 7,403,124 that are all herein incorporated by reference as if fully set forth. Eye tracking, eye focus determination, face detection, head detection, gaze determination, or the like may be determined by OS 301 using sensor 344. Sensor 344 may be an infrared sensor(s), an infrared camera(s), a camera(s), a range finding camera(s), an acoustic sensor(s), or an ultrasonic sensor(s). Any of these devices may be associated with sensor/radar system 216 or sensor(s) 126.

OS 301 may also place trees 324 substantially planar, proximately planar, in a similar field, or the like with windshield 313 of vehicle/conveyance 315 and display the view as such. For instance, trees 324 may be displayed on the sides of windshield 310 while maintaining undisplayed space in the center of windshield 310. For this configuration, OS 301 makes windshield 313 or vehicle/conveyance 315 and trees 324 substantially coplanar by adjusting the depth between different objects within field of view 326. This may be done by processing video of field of view 326 detected by sensor/radar system 216 or sensor(s) 126. For instance, a combination of one or more of an infrared sensor(s), an infrared camera(s), a camera(s), a range finding camera(s), an acoustic sensor(s), or an ultrasonic sensor(s) may be used for providing an augmented reality, hybrid reality, or mixed reality view to the driver(s)/passenger(s) of vehicle/conveyance 300.

The information on windshield may be adjusted and dynamically updated by OS 301 while the distance/speed/acceleration/grade/tilt between vehicle/conveyance 300 and 315 varies. By projecting content onto vehicle/conveyance 315 in front of vehicle/conveyance 300, message 320 may be easier and safer to read since the driver(s)/passenger(s) typically focuses on the vehicles(s) substantially directly in a substantially frontal view or field of view 326. In addition to windshield 313, information may be projected and/or augmented on back 328 of vehicle/conveyance 315. Projection by a projector device may especially be useful during night time. Information may also be projected or augmented on top of or on the outside of vehicle/conveyance 315.

During inclement weather 322, OS 301 may provide better safety by displaying on windshield 310 objects, trees 324, or vehicle/conveyance 315 while filtering/removing out from field of view 326 snow, rain, sand, dirt, fog, mist, or any other obstruction in field of view 326. This may be provided by OS 301 by processing video, images, photo, or video feedback in field of view 326 detected by sensor/radar system 216 or sensor(s) 126. For instance, a combination of one or more of an infrared sensor(s), an infrared camera(s), a camera(s), a range finding camera(s), an acoustic sensor(s), or an ultrasonic transceiver(s)/sensor(s) may be utilized by OS 301 for providing a clear, substantially clear, or partiality clear mixed/hybrid reality view to the driver(s)/passenger(s) of vehicle/conveyance 315. Similar bad or inclement weather mitigation may be provided by OS 301 to the rear view of vehicle/conveyance 300.

For further obstruction removal/avoidance, trees 324 may be digitally edited, processed, or removed from field of view 326 by OS 301 by accessing images of the area surrounding the tree. This may be accomplished by OS 301 using similar processing to those for snow, rain, sand, dirt, fog, mist, etc. mitigation explained herewith. Images of the area surrounding trees 324 may be provided using Google's Streetview information obtained via network adapter(s) 221. Images of the area surrounding trees 324 may also be obtained via network adapter(s) 221 from public/other databases, such as those having satellite images.

For further obstruction removal/avoidance, obstruction 350 may be digitally removed from stop sign 351 by OS 301. Obstruction 350 may be a tree, foliage, or any other substantially object blocking stop sign 351. This may be performed by OS 301 using similar processing to those explained above. Through windshield 310, the driver(s)/passenger(s) of vehicle/conveyance 300 will substantially clearly see the entirety of stop sign 351. These features may similarly be applied by OS 301 to an obstructed traffic light near stop sign 351 or if stop sign 351 is damaged/down. OS 301 may also determine that stop sign 351 is damaged, down, or non-operational by accessing or receiving information via network adapter(s) 221.

As another driver assistance mechanism, OS 301 may detect when a traffic light in field of view 326 has a burnt out light(s) or is non-operational. OS 301 then may augment a burnt traffic light to green, yellow, or red to be displayed as ON when appropriate to the driver(s)/passenger(s) of vehicle/conveyance 300. Detection may be performed using sensor/radar system 216 or sensor(s) 126. Detection may also be performed by OS 301 by using an image, photo, or video detection/recognition engine. Examples of image, photo, text, or character recognition engines are provided by U.S. Patent Publication Nos. 2011-0110594 or 2012-0102552 both herein incorporated by reference as if fully set forth.

Safety related augmentation of a traffic light may also be determined by OS 301 by accessing real-time traffic, street, road, or highway information by OS 301 via network adapter(s) 221. This information may be sourced by a municipality, state, or crowdsourced. OS 301 may coordinate this information by using position or location information of vehicle/conveyance 300 of different traffic lights via telematics or positioning devices 223. Safety related augmentation of a traffic light may also be determined by OS 301 obtaining Internet of Things (IoT) information via network adapter(s) 221.

With respect to pedestrian avoidance or safety, OS 301 may be configured to keep objects in field of view 326 within the primary vision lines of a driver(s)/passenger(s) of vehicle/conveyance 300. Using augmented reality, mixed reality, or hybrid reality systems of vehicle/conveyance 300, pedestrian 348 may be moved into the same substantially planar, proximately, or the like view of weather 314 or message 320 as an augmented image pedestrian 334. Pedestrian 348 may be augmented or overlaid by OS 301 and displayed on windshield 310 to appear on back 328 of vehicle/conveyance 315. In addition, to assist OS 301 or vehicle/conveyance 300 to avoid a collision with pedestrian 348, an object device associated with pedestrian 348 may communicate or provide assistance data to OS 301 or vehicle/conveyance 300.

As an advanced safety, driver assist, or collision avoidance feature, OS 301 may detect when tail lights 330, 331, or 332 are burnt out or non-operational. Burnt out or non-operational lights on vehicle/conveyance 315 may be augmented by corresponding lights and displayed on windshield 310 by OS 301 when needed as ON. OS 301 also replicates the proper color of any one of tail lights 330-332 as red, yellow, blue, white, or the like when it should be ON and displays it accordingly on windshield 310.

The safety related augmentation of a burnt out light may be determined by OS 301 determining parameters such as the speed of, acceleration of, deceleration of, momentum of, and/or distance to vehicle/conveyance 315. Speed, acceleration, deceleration, momentum, or distance parameters may be determined by vehicle/conveyance 300 using, in part, one or more sensors 126. Sensor/radar system 216 may also be used in combination with one or more sensors 126 to determine these variables substantially in real-time. The values of the parameters or state of vehicle/conveyance 315 may be communicated wirelessly via link 338 to vehicle/conveyance 300 such as by a V2V protocol.

Detection of when tail lights 330 or 332 are burnt out/non-operational may also be performed by OS 301 by image, photo, or video detection/recognition and geometric modeling. OS 301 may identify a tail light/tail lamp by determining and comparing distances between tail lights 330-332. Once the location/position of any one of tail lights 330-332 on back 328 is determined, using color (e.g. red, yellow, blue, or white) or light detection/recognition, OS 301 may determine if the tail light is working properly. Examples of image, photo, text, or character recognition engines are provided by U.S. Patent Publication Nos. 2011-0110594 or 2012-0102552 that are both herein incorporated by reference as if fully set forth. In addition, in combination with the bad or inclement weather mitigation system provided above, tail lights 330 or 332 may be clearly shown and virtually operated by OS 301 for safer driving. Thus windshield 310 may display a clear view of vehicle/conveyance 315 with operational lights regardless of weather or the status of the lights of vehicle/conveyance 315.

In addition to tail lights, OS 301 may be configured to detect any other lights or non-operational/partially operational components of vehicle/conveyance 315 using image, video, photo, acoustic, or any other sensor based recognition/detection. For instance, OS 301 can be used to determine the operation status of headlights or headlamps of a vehicle in proximity to vehicle/conveyance 300. In addition, the slope/tilt of vehicle/conveyance 315 may be determined or calculated by OS 301 in combination with sensor/radar system 216 or sensor(s) 126. The slope/tilt may be adjusted by OS 301 by factoring in the grade of the road and then used to determine if vehicle/conveyance 315 has a flat or low pressure tire(s).

Using speed, acceleration, deceleration, momentum, or distance parameters of vehicle/conveyance 315, determined in part by sensor/radar system 216 or sensor(s) 126, may help OS 301 estimate the driving behavior/mood/style of the driver(s)/passenger(s) of vehicle/conveyance 315. OS 301 may determine, such as by artificial intelligence (AI) modeling, if vehicle/conveyance 315 accelerates quickly, is speeding, moving aggressively, changes lanes aggressively, ran a red light, drove past a stop sign, or the like. OS 301 may also determine, such as by artificial intelligence (AI) modeling, if vehicle/conveyance 315 has a distracted driver(s)/passenger(s), has a distressed driver(s)/passenger(s), has a sick driver(s)/passenger(s), has a driver(s)/passenger(s) that is texting, has a driver(s)/passenger(s) that is talking on the phone, has a driver(s)/passenger(s) that is surfing the internet, has a driver(s)/passenger(s) doing work, has a driver(s)/passenger(s) that is eating, has a driver(s)/passenger(s) that is drinking, or like. Using one of more of these markers/determinations, OS 301 may warn the driver(s)/passenger(s) of vehicle/conveyance 300 accordingly.

Moreover, OS 301 may use an image, photo, or video detection/recognition engine to decipher license plate 336. Examples of image, photo, text, or character recognition engines are provided by U.S. Patent Publication Nos. 2011-0110594 or 2012-0102552 that are both herein incorporated by reference as if fully set forth. OS 301 may use license plate information to obtain the driving records, driving under the influence (DUI) records, drunk driving records, criminal records, ownership information, carfax information, credit reports, or the like. This information may be obtained by OS 301 from the Internet using via network adapter(s) 221. OS 301 may estimate the driving behavior/mood/style of the driver of vehicle/conveyance 315 using this information. OS 301 may then warn the driver(s)/passenger(s) of vehicle/conveyance 300 accordingly.

Moreover, OS 301 may use the derived or modeled information to detect/determine road rage or determine the driver of vehicle/conveyance 315 is a bad driver. In the case of vehicle/conveyance 300 being configured as fully autonomous/self-driving or hybrid autonomous, OS 301 may use one of the warning signs to adjust/adapt driving or respond accordingly. For instance, this information may trigger safety measure systems of vehicle/conveyance 300 such as precharging the brakes, preparing for a potential collision, tightening seat belts, any of the safety measures described herein, or the like. A hybrid autonomous or partially self-driving vehicle may be one where the primary driver is vehicle/conveyance 300 using OS 301 and the secondary driver is a person. A hybrid autonomous vehicle may also be one where the primary driver is the person and the secondary driver is vehicle/conveyance 300 using OS 301.

As a safety feature, OS 301 may also be configured to use sensor/radar system 216 or sensor(s) 126 to determine the sex, age, or race of vehicle/conveyance 315. Such detection may also be performed by using an image, photo, or video detection/recognition engine by OS 301. Examples of image, photo, text, or character recognition engines are provided by U.S. Patent Publication Nos. 2011-0110594 or 2012-0102552 that are both herein incorporated by reference as if fully set forth. If the driver of vehicle/conveyance 315 is detected as having long hair and bosoms, OS 301 may indicate the driver as female. If a driver of vehicle/conveyance 315 is detected as having wrinkles or grey/white hair, OS 301 may indicate the driver as older.

Sex, age, or race information may be used as a data point/metric/indication to provide to the driver(s)/driver(s) of vehicle/conveyance 300. Such information may result in driving that is adapted/adjusted. In the case of vehicle/conveyance 300 being configured as fully autonomous/self-driving or hybrid autonomous, OS 301 may use this information to adjust/adapt driving or respond accordingly.

In addition, OS 301 may use sensor/radar system 216 or sensor(s) 126 to determine when a driver to the side or behind of vehicle/conveyance 300 is facing down or away. Such detection may also be performed by using an image, photo, or video detection/recognition engine by OS 301. A driver may be identified as distracted when their head is tilted/directed down to text or use a mobile device. OS 301 may determine head or face position by using facial detection or recognition.

With respect to performing professional work or collaboration, OS 301 may be configured to selectively switch between any one of autonomous, hybrid autonomous, or driver controlled modes. Such mode changes may be provided to the driver of vehicle/conveyance 300 by haptic warnings of the driver's seat or steering wheel. For reading a book, document, or web information on windshield 310, a factor checker may be provided by OS 301 to driver(s)/passenger(s). Such a fact checker may parse phrases, sentences, statements, facts, or statistics and request a grade via network adapter(s) 221 to a service provider.

A service provider may be an artificial intelligent (AI) engine that searches the Internet for context related information. The results of the search may help check the accuracy of phrases, sentences, statements, facts, or statistics of information displayed on windshield 310. Part of the AI engine may also operate within OS 301. A service provider may also be a crowdsourcing service that asks a crowd to comment or grade the phrases, sentences, statements, facts, or statistics in the book, document, or web information. A service provider may also send the phrases, sentences, statements, facts, or statistics overseas or to a microtasker for grading as a lower cost option.

Any grades or comments may be received by OS 301 via network adapter(s) 221 from a service provider. OS 301 may then post side bubbles/notifications/sidenotes with grading accuracy from 1-100%. OS 301 may also provide color grades next to, using a badge, or on (such as with highlighting) respective phrases, sentences, statements, facts, or statistics for information displayed on windshield 310. For instance, green highlighting may indicate that displayed information has substantially high accuracy or rating. Red highlighting may indicate that a displayed statement or phrase has substantially low accuracy or substantially false. Similarly, color coded underlining may be used to display fact checking results. Such context may provide a driver(s)/passenger(s) or a user of object device 100 better confidence of the content or information in a displayed book, document, or web information.

In addition, a fact checker may operate by checking or confirming citations/footnotes. For instance, if information from a medical study is cited/referenced in a paragraph of a book, OS 301 will check the quality of the medical study and provide an accuracy, rating, or color grade(s). The quality of the medical study may be determined by OS 301 checking the prominence of the researchers, extent of peer reviews, size of the study, research center of the study, hospital that conducted the study, university that conducted the study, country of origin, or the like by searching the Internet or accessing related databases.

As another operation to reduce driver distraction and improve safety, vehicle/conveyance 300 or OS 301 may be configured to automatically generate a Twitter message. The Twitter message may be provided based on a voice command input or any other input given herein. In addition, a substantially automatic hash tag may be generated by using geocode information. The geocode information may be determined by vehicle/conveyance 300 or OS 301 using location/position information determined in part from telematics or positioning devices 223.

Telematics or positioning devices 223 may be configured similar to global navigation satellite system (GNSS) device 114. In addition to text and a geocode, vehicle/conveyance 300 or OS 301 may be configured to add a photo or image taken in response to a voice command input by a driver(s)/passenger(s). The photo or image may be taken by I/O devices 118 or one or more sensors 126, such as a camera. This configuration may give/share with Twitter recipients a view of the location/position of vehicle/conveyance 300. Similar to a Twitter message, a similar configuration may be provided for MMS by vehicle/conveyance 300, object device 100, or OS 301.

FIG. 3a is a diagram of steering wheel 356 having display 360 showing message 306. Display 360 may be attached/mounted by 358 to steering wheel 356 so that display 360 stays substantially static when steering wheel 356 is physically turned. Having a display on steering wheel 356 may allow easier reading of message 306 since a driver does not need to look away or to the right/side to see display 302. Steering wheel 356 may also light up such that it may notify a driver when a message is received.

In addition, hub/console area 365 of steering wheel 356 may be configured with a display device, such as a transparent or flexible display device. Different display devices given for one or more display devices 122 may be used for hub/console area 365. The display device may be substantially circular, substantiality square, substantially rectangular, or any other shape. In such a configuration, steering wheel 356 and its corresponding display may physically rotate. However, OS 301 may compensate for any clockwise rotation 370 or counter-clockwise rotation 368 by maintaining displayed information on hub/console area 365 virtually upright, substantially static, or in a readable position.

In addition, swipe gestures, slide gestures, or grip gestures may be accepted by a tactile sensor(s) on steering wheel 356. Substantially front area 362, substantially back area 366, or substantially around/circular area 364 may have a tactile sensor area(s) or tactile sensor layer(s) that operate with OS 301 to detect user inputs. The tactile sensor area(s) may use a capacitive sensing or conductance sensing circuitry to detect a skin based input. The tactile sensor area(s) or tactile sensor layer(s) may operate with OS 301 to detect single or multitouch user inputs.

A steering wheel based user interface or input device may be modeled around using gestures similar to notebook trackpads or touchpads. In addition, OS 301 may detect inputs or triggers on steering wheel 356 to take images or photos by I/O devices 118 or one or more sensors 126, such as a camera. Using steering wheel 356 to take photos may allow a driver of vehicle/conveyance 300 keep their hands on the wheel thereby increasing safety. The photo or image may be for an object in the substantially frontal view or field of view 326. Moreover, OS 301 may determine the specific object to take a photo of by using eye tracking, eye focus determination, face detection, head detection, gaze determination, or the like of a driver(s)/passenger(s) using sensor 344.

With respect to substantially front area 362, tactile sensor area(s) may be configured and placed substantially entirely on frontal circular area 363 or center hub/console area 365. The tactile sensor area(s) may also be configured or placed in selective common hand position(s)/point(s) area(s) on frontal circular area 363 or center hub/console area 365. The sensors in the tactile sensor area(s) may be laid out substantially in a curved grid or matrix to determine coordinates of an input or multitouch input. Substantially back area 366 or around/circular area 364 may be configured similar to those of frontal circular area 363 or hub/console area 365 explained above.

Tactile sensor area(s) on steering wheel 356 may allow a driver to control information displayed on windshield 310 while keeping their hands on the wheel. A grip gesture, such as detected by tactile sensor area(s) on substantially around/circular area 364, may control a speed or intensity of an input. For instance, a scrolling operation may go faster with a harder grip gesture. A grip gesture may be determined by pressure levels determined in part by OS 301 based on input detections by tactile sensor area(s). Haptic feedback on steering wheel 356 may also be used to communicate to the driver of vehicle/conveyance 300 the intensity of a grip gesture.

Moreover, a left grip gesture on steering wheel 356 may move a displayed object up or down on windshield 310. A right grip gesture on steering wheel 356 may move a displayed object left or right on windshield 310. A substantially similar strong intensity left grip gesture and strong intensity right grip gesture on steering wheel 356 may make an object displayed on windshield 310 fade or disappear. This input may especially be helpful since a driver may typically tighten the grips on a steering wheel when danger is eminent. A combination of left grip gesture and right grip gesture of substantially different intensities on steering wheel 356 may move a displayed object diagonally on windshield 310.

Substantially front area 362, hub/console area 365, substantially back area 366, or substantially around/circular area 364 may be configured with tactile sensor area(s) to detect inputs that OS 301 may determine as a substantially circular gesture motion. A substantially circular gesture motion may be similar to a swipe or slide gesture on a touch/multitouch screen or trackpad that may move information or objects displayed on windshield 310 in coordination with OS 301.

OS 301 with tactile sensor area(s) on steering wheel 356 may be configured to turn off gestures during a predetermined amount of an angle of wheel rotation. The angle of a wheel rotation may be determined by the handling system or steering wheel system of vehicle/conveyance 300. Moreover, OS 301 may recognize gestures during a wheel rotation based on the amount angular rotation amount, e.g. 45 degrees, and a detected/determined position of the driver's hand(s) relative to a tactile sensor area(s).

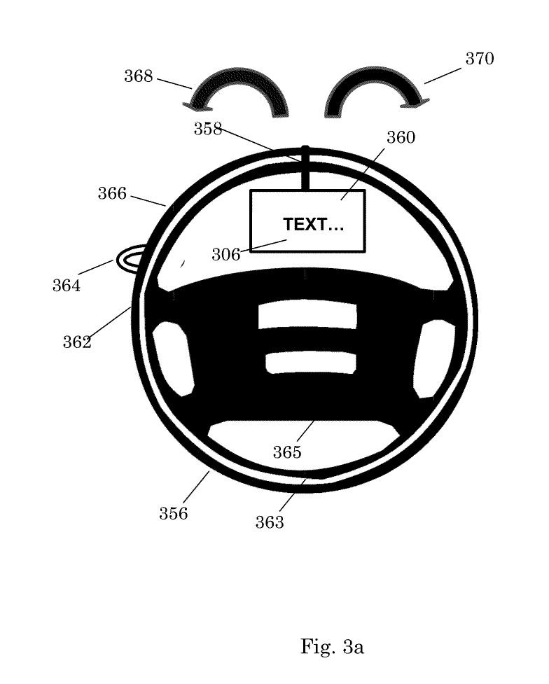

FIG. 4 is a diagram of vehicle/conveyance environmental detection. Vehicle/conveyance 400 may use sensor 402, sensor 404, smart antenna(s) 414, radiation pattern 412, or adaptive suspension 406 to detect curbs, cars, or any other object near vehicle/conveyance 400. The vehicle/conveyance environmental detection in FIG. 4 may provide 360 degree vision. Sensor 402 or sensor 404 may be configured as part of sensor/radar system 216 or one or more of sensor(s) 126.

Although not shown, sensor 404 may also be located on both sides of the front or back bumper of vehicle/conveyance 400. As another example, rather than in the bumpers, sensor 404 may be configured in the headlights or tail lights of vehicle/conveyance 400. Headlight(s) 408 or tail light(s) 416 placement of sensor 402 may provide a smooth bumper (i.e. no installation groves 405) while having substantially line of sight emission/detection. Sensor 402 may also be configured in the front and back of vehicle/conveyance 400.

A potential curb or potential curb collision may be detected by beam 410 reflecting off a nearby curb. Beam 410 may be radio frequency, ultrasonic, or any other range finding radiation. Beam 410 may be emitted via smart antenna(s) 414 by one or more of an infrared transceiver(s), a range finding transceiver(s), acoustic transceiver(s), an ultrasonic transceiver(s), or the like integrated in vehicle/conveyance 400 and controlled by OS 301. The reflection/absorption of beam 410 may be determined by any one of sensor 402, sensor 404, adaptive suspension 406, or the component(s) explained of vehicle/conveyance 200. When a potential curb or potential curb collision is detected, vehicle/conveyance 400 may automatically slow down or pre-charge brakes in order to provide a driver maximum stopping power.

In addition, vehicle/conveyance 400 may use systems such as Mercedes-Benz's Brake Assist or PRE-SAFE system to take preemptive measures to reduce damage or passenger injury when danger or a collision is eminent. Vehicle/conveyance 400 may also automatically turn its steering wheel towards the road such that it does not continue driving on a sidewalk. The curb avoidance system may be performed by OS 301 in coordination with the component(s) explained of vehicle/conveyance 200.

An amount of automatic maneuvers or speed reduction, by automatic braking, may be performed by vehicle/conveyance 400 depending on current speed or angle/tilt. The angle/tilt of vehicle/conveyance 400 may be determined by using the electronic stability program (ESP) of vehicle/conveyance 400.

The curb material/composition near vehicle/conveyance 400 may determine by OS 301 based on reflection/absorption of beam 410. In addition to curb material/composition, beam 410 may be used to determine dirt, gravel, or a road shoulder that may be used for lane tracking for vehicle/conveyance 200 or 400. Beam 410 or radiation pattern 412 may be generated using beamforming or beam steering. Beam 410 or radiation pattern 412 may be provided by sensor/radar system 216. Details of providing beamforming or beam steering may be found in U.S. Patent Publication No. 2012-0091371 that is herein incorporated by reference as if fully set forth.

OS 301 in coordination vehicle/conveyance 300 or using any component(s) of vehicle/conveyance 200 may dynamically recognize any one of a tone, common sounds/notifications, common sounds/audible notifications of a mobile application/OS, vibrations, or user specific sounds/notifications by an object device 100 (e.g. mobile phone) in order to adapt the computing environment and provide notifications/notices. OS 301 may recognize a ringtone/audible notification of a mobile computing device and automatically silence the radio, reduce background noise (such as by noise cancellation), close window(s), close a sunroof, or adjust any other systems currently running so that a driver(s)/passenger(s) is provided an optimum call environment. OS 301 may also prompt the driver(s)/passenger(s) on windshield 310 when a call/text message is detected.

OS 301 may also prompt the driver(s)/passenger(s) on windshield 310 when a call/text message is missed because of a noisy vehicle/conveyance 300 environment and a call ringtone/text message notification sound emitted by object device 100 is detected. OS 301 may also be notified by object device 100 of a missed call or text message, for instance substantially without a data connection or Bluetooth connection being setup, by non-audible or above human hearing frequency notification signal of a call or text message.

OS 301 may be configured to receive inputs. Inputs may be used to control any of the messaging or controls explained for vehicle/conveyance 300. An input may to be a touch input, a touch gesture, a gesture, a multi-touch input, an air gesture, a gesture in the air, a voice recognition input, voice recognition, a speech recognition input, speech recognition, a motion based input, or the like. For instance, a sensor system such as that provided by Leap Motion may be integrated into vehicle/conveyance 200 and used by OS 301. Tracking or gesture detection engines or systems are given by U.S. Patent Publication Nos. 2010-0201811, 2011-0025827, 2011-0096182, 2011-0188054, 2011-0211044, 2012-0050488, U.S. Pat. No. 8,166,421, and PCT Publication No. WO 12/011044 that are all herein incorporated by reference as if fully set forth. Voice, speech, or audio recognition engines are described in U.S. Patent Publication Nos. 2013-0096915, 2012-0290299, or 2012-0215543 and U.S. Pat. No. 8,219,397 or U.S. Pat. No. 7,680,661 that are all herein incorporated by reference as if fully set forth.

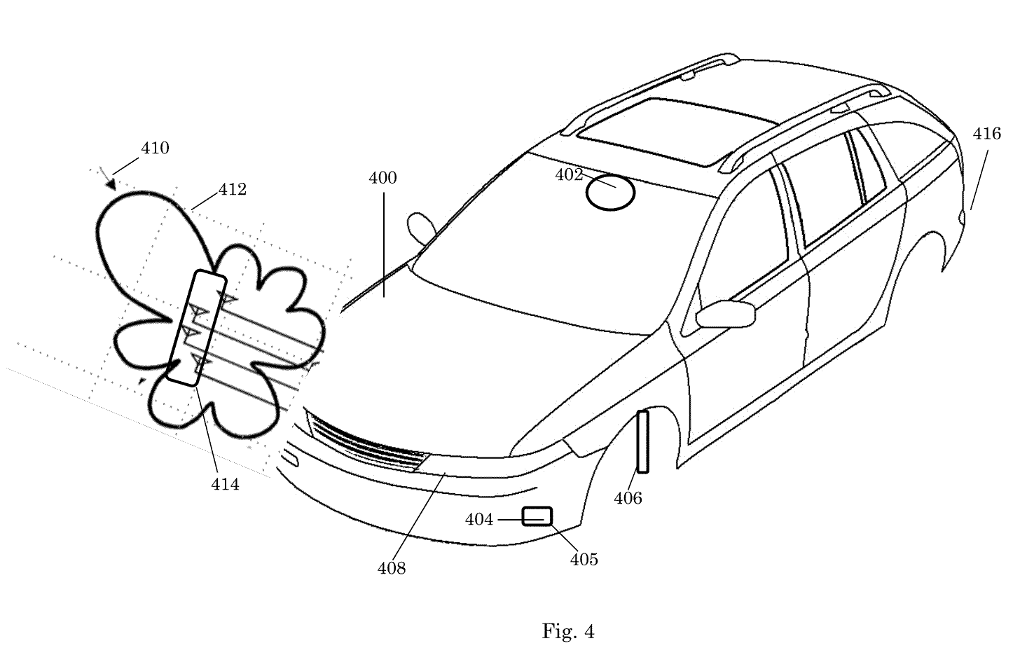

FIG. 5 is a diagram of an advanced input determination configuration for a mobile or fixed computing environment. The forthcoming advanced input determination configuration may be branded as PClix, HotClix, SureClic, or the like. The forthcoming may be particularly beneficial to touch/multi-touch based inputs and devices that have lower computing power in comparison to a current state of the art. For instance, and one of many examples, SureClic may resolve a problem where a hyperlink is touched, on a touch based display, while a webpage is still in the process of being loaded. However, instead of the touched hyperlink being selected an incorrect hyperlink is selected instead.

At time T₁, desired input 504 of object 506 on displayed content area 502 may not be properly detected by object device 100/OS 108 due to downloading lags/delays, erratic network connections, an overloaded network, central processing unit (CPU) overload, processing lags/delays, memory processing lags/delays, rasterizing lag/delays, display processing lags/delays, bus lags/delays, or the like. As a result, at time T₂ undesired input 508 of object 510 on shifted/repositioned/moved/substantially loaded displayed content area 503 is received by object device 100/OS 108 and information related to object 510 is mistakenly fetched/retrieved.

Object 506 or 510 may be a hyperlink, soft button, image, photo, thumbnail, icon, HTML information, Java information, a link, or the like. Shifted/repositioned/moved/substantially loaded displayed content area 502-503 may be part of a browser environment, a Java environment, a flash environment, an HTML5 environment, a mobile application environment, a fixed computer application environment, any graphic user interface (GUI) environment, or the like.

Undesired input 508 may provide undesired results to a user, service provider, application programmer, or the like. For instance, a large file size object or advertisement/mobile ad may be inadvertently selected or clicked. Undesired input 508 may then result in wasted time and resources such as network bandwidth, network resources, CPU processing, memory processing, display processing, or the like. In particular, vast network resources may be wasted if undesired input 508 of object 510 results in an undesired large sized download.

Displayed content area 505 provides a configuration for a mobile or fixed computing environment where a desired input 512 of object 506 is properly determined. Object device 100/OS 108 may be configured to substantially prioritize desired input 512 of object 506 on displayed content area 505 and save desired input 512 for subsequent retrieval until displayed content area 505 is downloaded/processed. In such a configuration, desired input 512 may be copied, stored in memory/register, dynamically stored in RAM, stored in cache, captured by a Java plugin, registered by a script, determined by a HTML5 component, or the like. Desired input 512 may also be determined as described herein by object device 100/OS 108 working in coordination with a server or cloud computing component.

In addition, object device 100/OS 108 may be configured to use an optimized/specialized interrupt protocol during a heavy download process. Such an interrupt protocol may determine when an input is desired or undesired during a heavy download or processing period. For instance, during a download a touch input received by object device 100 may trigger a substantially urgent interrupt such that it is processed by one or more processors 102. The input may be processed once a download, such as a webpage or web object, is substantially fully downloaded, loaded, or processed.

Moreover, object device 100/OS 108 may work in coordination with a data/dynamic link library (DLL) or kernel to prioritize an input during a download, loading, or heavy processing period such that an undesired input is not mistakenly executed. One or more processors 102 may also be configured to more periodically check for instructions/requests from a kernel during a download to determine if a desired input was received.

Moreover, desired input 512 may be determined by object device 100/OS 108 by having zones in an application component displayed in content area 505. In such an arrangement, zones 513 may be used to discern a desired from undesired input. For instance, an object in zone 514 may be repositioned/moved/shifted during a download/processing time period substantially down, up, left, or right such that new object(s) come into zone 514. If a potential input is received substantially in the time period of repositioning/movement/shifting, object device 100/OS 108 may be able to determine that the new object(s) in zone 514 is an undesired input/selection. Such a determination may be performed by comparing the potential input to the amount of shifting/repositioning/movement during the time period.

The operations and configurations of FIG. 5 may also be provided by vehicle/conveyance 300 or OS 301. For instance, an undesired input may occur when a voice/speech command or air gesture is mistimed during a download. This may happen since a data connection can be very erratic in a vehicle, especially at high speeds.

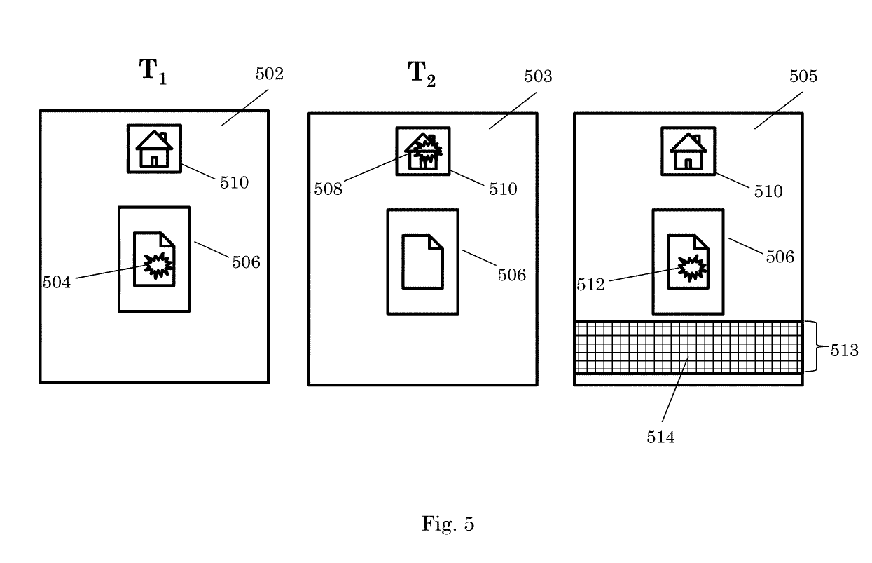

FIG. 6 is a process 600 of a vehicle/conveyance computing or OS platform. Vehicle/conveyance 300 or OS 301 may retrieve a document, message part, or information (602). Such information may be retrieved from memory 106 or other digital storage medium in vehicle/conveyance 300. Such information may also be retrieved online via one or more network adapters 128 such as from the Internet, from a server, or the cloud. The document, message part, or information may be substantially optimized and displayed on a car part, windshield, or on another conveyance (604).

As described above, substantial optimization may be displaying just an image from a document or message part. Also as described above, substantial optimization may be to augment or overlay information, such as by image processing by OS 301, on the back of another conveyance on a windshield display with information. Having information displayed on a windshield as if it is on the back of another conveyance, such as one substantially directly in front, may increase safety and usability. Vehicle/conveyance 300 or OS 301 may also monitor the environment and adapt/adjust the display of document, message part, or information in order to increase safety, comfort, or usability (606 or 608). For instance, changes to an environment may include receiving a new call or message in a car or conveyance. Changes to the environment may also include physical changes, such as weather changes or a potential collision.

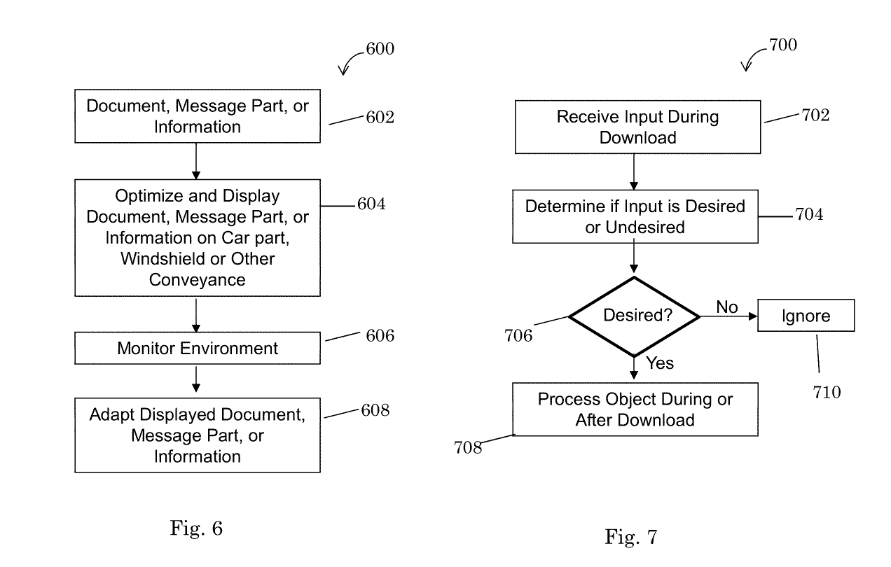

FIG. 7 is a diagram of a process 700 of advance input determination. An input may be received during a download of information (702). An input may be a touch, voice command, speech command, click, key press, etc. In addition to a download, as given above, an input may also be received during other operations. Object device 100/OS 108 may determine, as described above, if the input is desired or undesired (704 or 706). If it is desired, the object selected/clicked/touched in relation to the input substantially during or substantially after the download is processed (708). If it is not, the input is ignored (710).

Software or hardware components described herein may also include an accelerometer, an electronic compass (e-compass), a gyroscope, a 3D gyroscope, a 3D accelerometer, a 4D gyroscope, a 4D accelerometer, or the like. As mentioned above, sensor/radar system 216 or sensor(s) 126 may operate with respective software engines/components in software/OS 108 or OS 301 to interpret/discern/process detect measurements, signals, stimuli, input, or the like. Any of the exemplary components, sensors, devices, or the like listed may be implemented in hardware and/or software when possible.

Although features and elements are described above in particular combinations, each feature or element may be used alone without the other features and elements or in various combinations with or without other features and elements. The methods, processes, or flow charts provided herein may be implemented in a computer program, software, hardware, configured circuitry, or firmware incorporated in a computer-readable storage medium for execution by a general purpose computer, a processor, or a controller. Examples of computer-readable storage mediums include a read only memory (ROM), electrical signals, a random access memory (RAM), a register, cache memory, semiconductor memory devices, magnetic media such as internal hard disks and removable disks, magneto-optical media, and optical media such as CD-ROM disks, digital versatile disks (DVDs), and BluRay discs.

Suitable processors include, by way of example, a general purpose processor, a multicore processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement hardware functions for use in a computer or any host computer. The programmed hardware functions may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

Any of the displays, processors, memories, devices or any other component disclosed may be configured, produced, or engineered using nanotechology based nanoparticles or nanodevices.

What is claimed is:

1. A vehicle based computer, in a vehicle, comprising:
a processor configured to communicate with a windshield configured with a transparent display;
an image sensor, in communication with the processor and the vehicle based computer, configured to capture a substantially frontal view of the vehicle, wherein the substantially frontal view of the vehicle includes a back of another vehicle;
the processor configured to load an in vehicle work environment operating system;
the vehicle based computer configured to overlay, in the substantially frontal view of the vehicle, a document provided from the vehicle work environment operating system; and
the vehicle based computer configured to display, on at least part of the transparent display, the document as substantially proximately planar with the back of the another vehicle.

2. A method performed by a vehicle based computer in a vehicle, the method comprising:
communicating, by a processor, with a windshield having a transparent display;
capturing, by an image sensor in communication with the processor and the vehicle based computer, a substantially frontal view of the vehicle, wherein the substantially frontal view of the vehicle includes a back of another vehicle;
loading, by the processor, an in vehicle work environment operating system;
overlaying, by the vehicle based computer in the substantially frontal view of the vehicle, a document provided from the vehicle work environment operating system; and
displaying, by the vehicle based computer on at least part of the transparent display, the document as substantially proximately planar with the back of the another vehicle.
